(19) United States
(12) Patent Application Publication
(10) Pub. No.: US 2002/0193895 A1
(43) Pub. Date: Dec. 19, 2002

(54) Enhanced encoder for synchronizing multimedia files into an audio bit stream

(76) Inventors: Ziqiang Qian, Barrington, IL (US); Zheng Ouyang, Chicago, IL (US); Scott Bytnar, Sleepy Hollw, IL (US); Erik C. Attkisson, Chicago, IL (US)

Correspondence Address: Adam K. Sacharoff, Hamman & Benn, 10 South LaSalle Street, Chicago, IL, 60603, US

(21) Appl. No.: 10/174,644

(22) Filed: Jun. 18, 2002

Related U.S. Application Data
(60) Provisional application No. 60/298,966, filed on Jun. 18, 2001.

(51) Int. Cl. G06F 17/00

(52) U.S. Cl. 700/94

(57) ABSTRACT

In one embodiment of the present invention a user interface for synchronizing multimedia files into an audio bit stream is provided. The interface includes the ability to retrieve an audio file having at least a voice recording and retrieve multimedia files. When the multimedia file includes lyrical data that corresponds to the voice recording on the audio file, the interface provides the ability to define syllable tags within the lyrical data. The interface may then synchronize the at least one multimedia file with the audio file, and when the multimedia file includes lyrical data, synchronize the lyrical data with the voice recording in accordance with the syllables tags. Such that the synchronizing generates an intermediate file that includes for each multimedia file at least one corresponding time stamp to indicate the position and time for where the multimedia file is to be synchronized within the audio file. In addition, the interface includes the ability to encode the audio file with the at least one multimedia file to generate a single audio bit stream, wherein the encoding uses the intermediate file to position and encode the at least one multimedia file with the audio file such that a single audio bit stream is generated that includes embedded synchronized multimedia files.

### CROSS-REFERENCE TO RELATED APPLICATIONS

This application claims the benefit of U.S. Provisional Patent Application having Ser. No. 60/298,966 and filed on Jun. 18, 2001 and hereby incorporates the provisional application by reference.

### FIELD OF THE INVENTION

The present invention relates to encoders used to encode audio signals into bit streams and, in particular to an enhanced encoder for synchronizing data into an audio bit stream.

### BACKGROUND OF THE INVENTION

The present invention is an enhanced encoder used for embedding information and multimedia, which may be both static and dynamic, into an audio bit stream. Any bit stream may be used, one commonly used bit stream is MPEG bit streams, which are defined by the International Organization for Standardization (ISO/IEC) for the coding of motion pictures and associated audio data. In addition the enhanced encoder may be capable of being performed according to other similar standards, such as AC-3, WMA, AAC, EPAC, Liquid Audio, G2 and other frame based audio format standards such as compact disc (CD) and mini disks (MIDI).

While other encoders are available in the prior art, the present invention permits the user to have the capability of embedding synchronized multimedia files into or with the bit stream. The present invention is a synchronization and compiler tool for synchronizing and converting lyrics, graphics, text, other electronic media, and data into a proper format.

### SUMMARY OF THE INVENTION

In accordance with the present invention a graphic user interface is provided that permits a user to synchronize multimedia file into an audio bit stream. The final encoding of the synchronized multimedia files and the audio file may be done such that a single audio bit stream is created. While not specifically outlined in the present invention, the multimedia files may either be synchronized within audio frames that make up the audio bit stream or attached to the audio frames such that when played the multimedia files are played in accordance with the synchronization.

The graphic user interface provides for both auto synchronization and manual synchronization, and would support input devices that allows for easy visual processing of the multimedia files. The interface further provides a preview function that permits the user to check and review the synchronization project prior to encoding the project to an audio bit stream.

The process of synchronization begins with the input of an audio file that is converted either outside of the present invention of within the present invention to a WAV file. The WAV file is played initially such that a single audio WAV signal is generated along with a time frame for the entire audio file. The user interface may then load various multimedia files, such as but not limited to lyrics, images, text files, video files, info tags, other audio files, etc., into the current project. The text files and lyrics may also be created in a text editor integrated within the present invention. The files may be automatically synced with the WAV signal by having the system place all of the files sequentially in order. The user may also manually manipulate the auto synced files or manually place the multimedia files in a specific time position along the WAV signal. Once placed, the multimedia file becomes time stamped in a position that matches the position in the WAV signal. When synchronizing lyrics or text files, the individual lyric or even character may be time stamped to easy the lyric is displayed or highlighted at the precise moment.

At any point during the synchronization, the user may preview the project without having to encode the audio bit stream and then decode it for playback. The preview function takes the WAV file and an intermediate generated file and plays back the two files simultaneously. When playing the intermediate file, if the system comes across a link to a multimedia file, the system compares the time stamp of the multimedia file to the current time position of the WAV playback. When the time stamp matches then the multimedia file is played. The preview function further provides the user with the means to check the synchronization such that the multimedia file could be resynchronized if needed.

Once the synchronization is complete, the WAV file and the intermediate file along with the multimedia files are encoded to a single audio bit stream. However, if the purpose of the synchronization is to playback a karaoke song, then it is possible that a second WAV file is encoded with the intermediate file and multimedia files. With karaoke songs, the music is played without the original artist's voice. While the first WAV file would probably contain the music and original artist's voice such that the user may properly synchronize the lyrics, the final encoded audio bit stream would include the second WAV file, such that during playback, the person player the final encoded audio bit stream would receive an audio file that contains the original music but not the original artist's voice.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a main window for a graphic user interface in accordance with the present invention for the synchronization of multimedia data with an audio file;

FIG. 2A is a table illustrating the functions associated with the File drop down menu from FIG. 1 along with descriptions of such functions;

FIG. 2B is a table illustrating the functions associated with the Edit drop down menu from FIG. 1 along with descriptions of such functions;

FIG. 2C is a table illustrating the functions associated with the Skins drop down menu from FIG. 1 along with descriptions of such functions;

FIG. 2D is a table illustrating the functions associated with the Load drop down menu from FIG. 1 along with descriptions of such functions;

FIG. 2E is a table illustrating the functions associated with the Synchronize drop down menu from FIG. 1 along with descriptions of such functions;

FIG. 2F is a table illustrating the functions associated with the Playback drop down menu from FIG. 1 along with descriptions of such functions;

FIG. 2G is a table illustrating the functions associated with the View drop down menu from FIG. 1 along with descriptions of such functions;

FIG. 2H is a table illustrating the functions associated with the Help drop down menu from FIG. 1 along with descriptions of such functions;

FIG. 3 is a screen shot of a browser window invoked by the present invention when previewing or playing projects or encoded bit streams;

FIG. 4 is a partial screen shot of the time window used to track the specific time frames associated with a WAV file;

FIG. 5 is a table representing the tool bar icons from FIG. 1;

FIG. 6A is a table representing the Project functions that may be used to create, save, and modify projects and their properties;

FIG. 6B is a table representing the Synchronization functions that may be used to synchronize the multimedia data with the audio file;

FIG. 6C is a table representing the Utility functions that may be used to create, save, and modify projects and their properties;

FIG. 6D is a table representing the Encoding functions that may be used to encode projects;

FIG. 6E is a table representing the Playback functions that may be used to play projects;

FIG. 7 is a dialog box that may be used to indicate to the user that a specific file was not found;

FIG. 8A is a dialog box that may be used to allow the user to create a new project;

FIG. 8B is a table representing various property fields that may be used to distinguish the project, wherein such fields may be mandatory, optional or automatic;

FIG. 9 is a dialog box that permits the user to enter various project property fields tabulated in FIG. 8B;

FIG. 10 is a partial screen shoot of the main window illustrating lyric synchronization in accordance with one embodiment of the present invention;

FIG. 11 is a dialog box, which may be invoked by clicking on a specific lyric represented in the Sync Times window from FIG. 10, that allows a user to manually adjust the synchronization placement of such lyric;

FIG. 12 is a settings dialog box that may be invoked to adjust the synchronization of the lyrics and edit lyrics and other text multimedia data files;

FIG. 13 is the setting dialog box from FIG. 12 will the Lyrics Source File tab initiated such that the lyrics may be edited;

FIG. 14A is settings dialog box from FIG. 12 with the lyrics clip board tab initiated showing the current copied lyrics;

FIG. 14B is the synchronization window illustrated in FIG. 1, showing that the lyrics placed on the Word Sync Bar may be copied;

FIG. 15 is a tree structure of Info Tags that may be used by the present invention to organize and invoke both unsynchronized and synchronized multimedia data;

FIG. 16 is an Info Tag window illustrating the tree structure, dependency and properties of a specific Info Tag;

FIG. 17 is a flow chart showing the encoding process of the present invention;

FIG. 18 is a block diagram illustrating various functions employed in one embodiment of the present invention;

FIG. 19 is a block diagram illustrating the synchronization process for one embodiment of the present invention; and

FIG. 20 is a block diagram illustrating the preview function for one embodiment of the present invention.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

In one embodiment, an input and output device, such as a mouse, for “clicking” or selecting graphic elements as well as a keyboard for inputting and editing, are used to manage and maintain the encoder features. Other input devices may similarly be used. Software development environments can integrate visual and source views of the components through use of certain features such as, for example, drag-and-drop. The drag-and-drop feature allows a software developer to modify the property values associated with the graphic user interface or “GUI” component while simultaneously viewing the modifications to provide the user with a type of virtual processing. The virtual processing pattern removes the dependence between components, because components at all levels have very little interdependence between inner components. It makes the systems easier to modify and upgrade, such that individual components may be replaced rather than replacing entire products. These components may be downloaded and installed using standard Internet technologies. Illustration figures used throughout represent a general overview of the graphical user interface for the windows and features used by the enhanced encoder platform. The illustrations used throughout are for example only and are not used to limit or restrict the scope of the claims or the invention.

The present invention provides for an enhanced encoder for creating an interactive or synchronized multimedia bit stream. The bit stream is an audio bit stream that either includes the multimedia embedded within the frames at a specific location that causes the multimedia to be synchronized therewith, or the multimedia may be time stamped and encoded along with the audio file to form a single encoded audio bit stream. The ability to embed data with the audio frames or to time sync the data with the audio frames creates an audio bit stream with synchronized data. The multimedia data or files referred to herein include but are not limited to both static and dynamic data. Static data is used to denote data types that do not change, such as textual data, video data or audio data. Dynamic data is used to denote data types that may change, such as hypertext data, or links to objects or web pages.

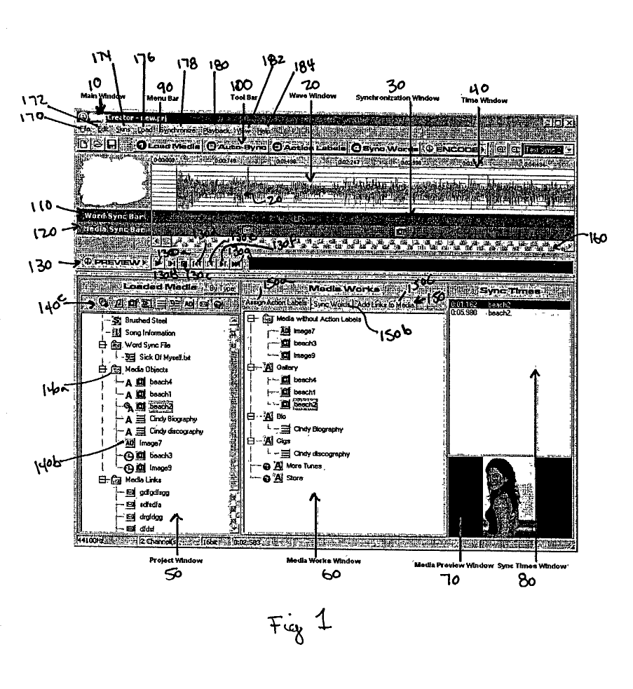

Referring to FIG. 1, there is shown in but one embodiment of the present invention a graphic user interface window display, referred to herein as the main window 10. The graphic user interface may be used as one means to implement the functions of the enhanced encoder in accordance with the present invention, which synchronizes data into or an audio file.

The main window 10 may be separated into various sub windows, such as but not limited to a wave window 20, a synchronization window 30, a time window 40, a project window 50, a media window 60, a media preview window 70 and a sync time window 80. In addition various tool bars may be used or activated to handle various functions. The tool bars included are a menu bar 90, a main tool bar 100, a word synchronize bar 110, a multimedia synchronize bar 120, a preview bar 130, a project tool bar 140, a media tool bar 150, and a time scroll bar 160.

The windows and their functions will now be discussed in greater detail. When an audio file is loaded to start a current project, the audio file may be of any well known formatted bit stream or other raw data formats, such as but not limited to MIDI, WMA, MPEG, WAV, AAC, etc. The loaded music file is first converted to a WAV file before it is used. The conversion may be built into the enhanced encoder or may be done outside the enhanced encoder environment and converted using other known converter programs. Once the audio bit stream is converted into a WAV audio file, the WAV audio file is played; this may be done by pressing the control buttons 130a through 130g on the preview tool bar 130. These control buttons include play 130a, pause 130b, stop 130c, beginning 130d, rewind 130e, fast forward 130f and end 130g. While the WAV audio file is being played for the first time, a single channel waveform is created and remains displayed in the WAV window 20 while the current project is opened. A vertical indicator 25 is displayed while the WAV audio file is played to indicate the current position. Moreover, the control buttons may be used throughout the synchronization process to play any portion or the entire WAV file.

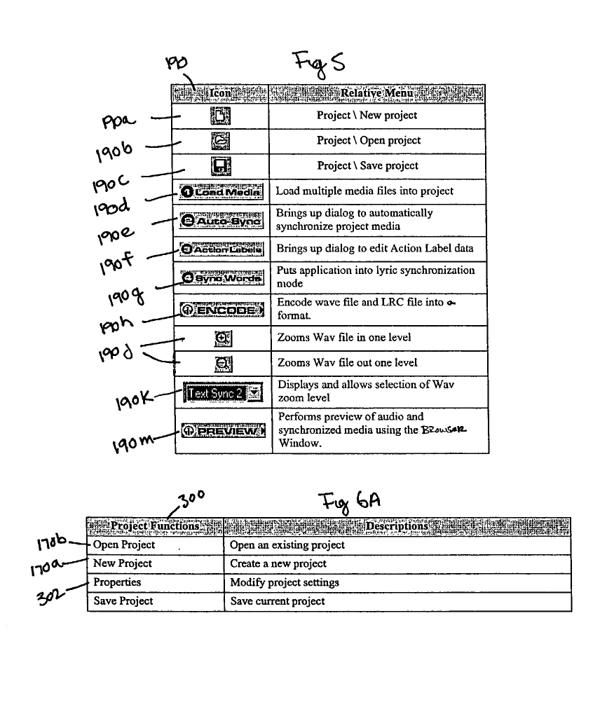

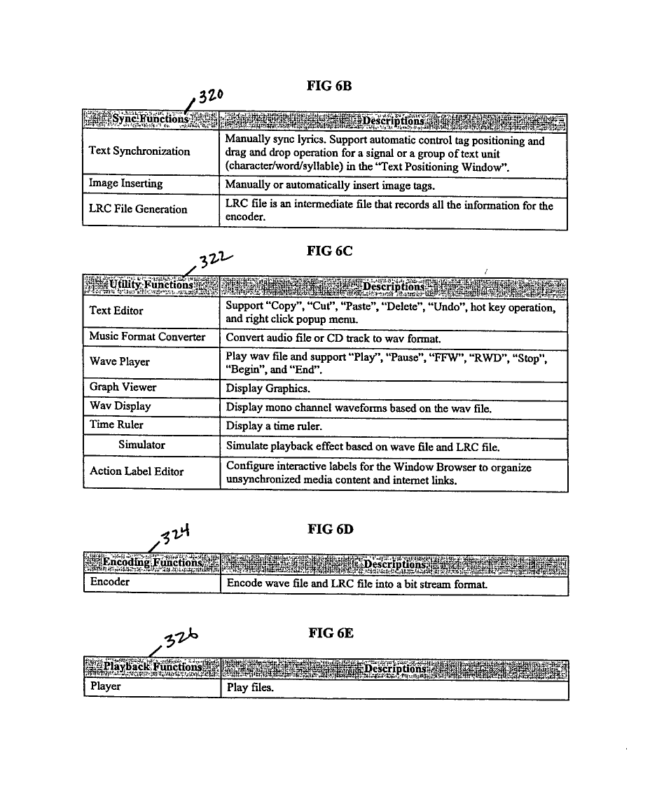

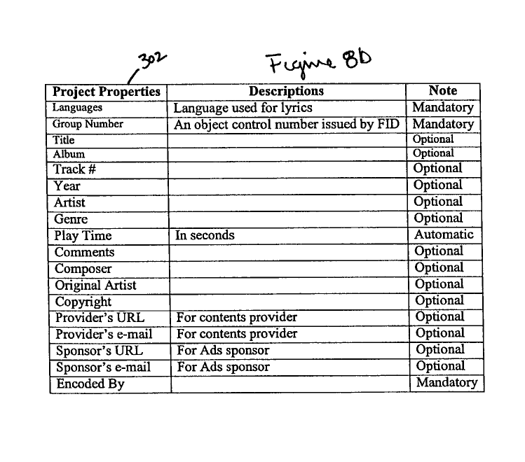

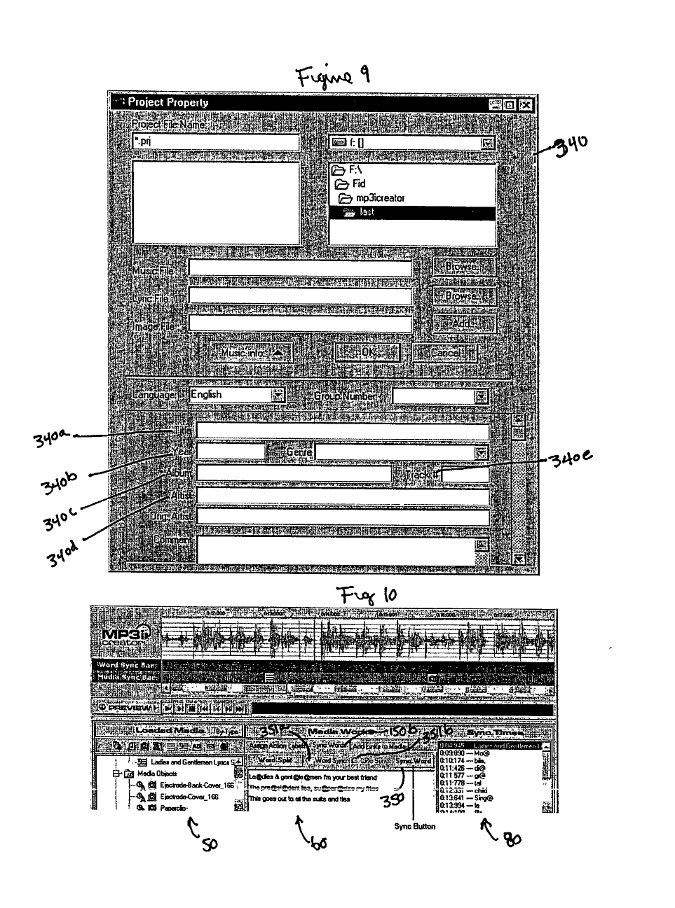

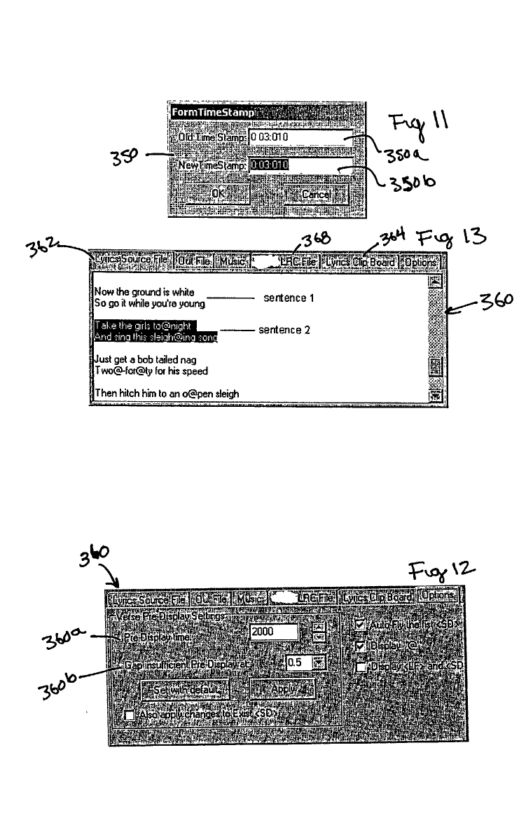

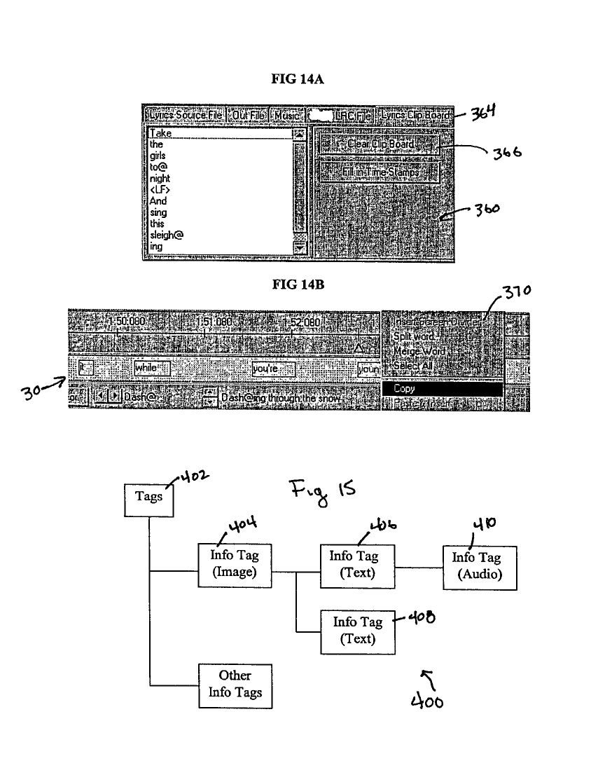

A time window 40, also shown in FIG. 4, is displayed next to the WAV window 30 in order to assist the user in synchronizing the multimedia data. The time window 40 is marked in milliseconds and there may be two end arrows 42 and 44 pointed to previous and next time frames, respectively. If any of those arrows is clicked, the time frame will be switched to the one it pointed to. While playing, a cursor 46 moves along with the indicator line 20 to indicate the current time. The cursor 46 can also be dragged to another position in the time frame to jump to a specific position. Additional drag and click features normally found in a graphic user interface may also be present. The user may also scroll through the WAV file by using the scroll bar 160, FIG. 1.

Throughout the current project multimedia files may be loaded, as discussed in greater detail below, and displayed in the project window 50. As the multimedia files are synchronized with the audio file, the multimedia elements appear along the Word Sync Bar 110 or the Media Sync Bar 120 in the Synchronization window 30. The Word Sync Bar 110 is used to synchronize the lyrical data while the Media Sync Bar 120 is used to synchronize additional multimedia data. In addition the multimedia elements will also appear in the media words window 60, discussed in greater detail below.

When the multimedia files, such as images, text files, lyric files, video files, audio files, advertisement images or the such, are loaded into the current project, the enhanced encoder sorts the files in the project window 50 under separate folders. As such advertisement images may be loaded under the Media Objects folder 140a in a subfolder AD 140b (or advertisement). As illustrated in FIG. 1, within the project window 50 various icons may be used to denote various objects: a camera icon may be used to denote a picture; a musical note icon may be used to denote the audio file; a globe icon may be used to denote a dynamic link, such as a hyperlink or URL address; an i icon may denote information regarding the song; and envelopes may be used to denote additional text files. Moreover, some if not all of the Load menu 176 functions, discussed in greater detail below, may also be accessed through short cut icons listed on the project tool bar 140c.

As the multimedia file is placed on the word sync bar 110 and media sync bar 120, the same multimedia file is placed in the media works window 60. The media works window 60 is used to track all of the multimedia files that have already be currently placed or synchronized along the WAV file. Three tabs may be accessed in the a media tool bar 150 associated with the media works window 60, which include an assign action label 150a, a sync word tab 150b and an add links to media tab 150c. The assign action label tab 150a, switches the media works window 60 to a window that displays the action labels and the multimedia files assigned thereto. The sync word tab 150b, also discussed in greater detail below, switches the media works window 60 to a window that displays the lyrics placed in the word sync bar 110. The add links to media tab 150c switches the window to permit the user to add media links. When the user has synchronized a multimedia file, the exact placement of the synchronization is displayed in a sync times window 80. Any specific multimedia file that is highlighted in the sync times window 80 is further previewed in a media preview window 70.

At any point during the process of synchronizing the multimedia files, the user has the ability to preview or run the project. Rather then encoding the project and then running the project through a media player, such as a portable music player, the user can preview the project without having to encode and then decode the audio bit stream.

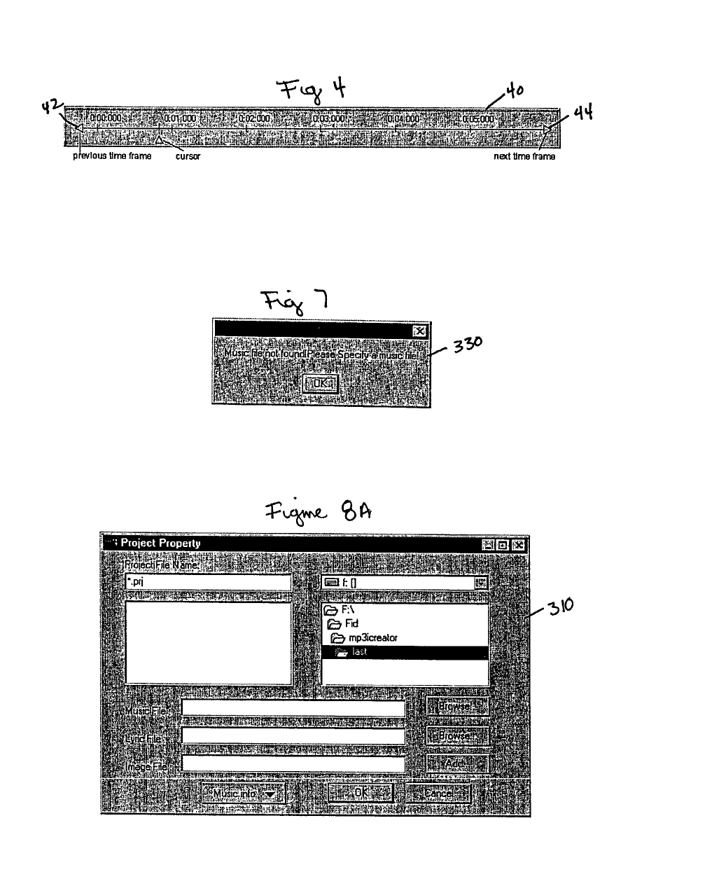

The user can preview the project by activating the preview function 130. During preview the project is viewed in a browser window 200, illustrated in FIG. 3. Moreover, the browser window 200 would have the same features if viewed by a viewer playing the finished project on another terminal or portable player as the browser capabilities may be downloaded into a portable player or personal computer. Since the synchronized multimedia files are encoded within or with an audio files, the encoded project will play on any typical player or personal computer with the capabilities to view the formatted or encoded project. However, the full effects of the present invention would be best viewed through an aforementioned browser with the viewer having the capabilities to interact with browser through a mouse, keyboard, or other input devices such as but not limited to a light pen, touch screen, etc.

Turning to FIG. 3, the browser window 200 includes various sub windows or zones, which display different information. For example, record information may be displayed in an song-info zone 205, and text data may be displayed in a text zone 210. The lyrics may be scrolled across in a lyric window 215. Graphical data such as images or videos may be displayed in a multimedia window 220. The play-back may also be controlled through volume controls and control buttons that stop, play, fast forward or rewind the preview, accessed in a control window 225. Additional multimedia data may be accessed by point and click features, which will bring up the different multimedia data in the multimedia window 220. For example, the artists e-mail or official web-site may be invoked through a personal linked zone 230. By clicking one of these, the user will be transferred to the artist's e-mail or web-site through the Internet, if the connection is available. Additional multimedia data may be viewed and accessed through secondary zones 235, which may include a gallery of photos, a bibliography on the artist, recent concert information, and links to download or view other songs by the artist or links to the third parties web-site. Lastly, additional advertisement zones 240 are utilized to display dynamic and static advertisements. As such, when the user has the ability to interact with the multimedia window 220 through various input devices, the user may have the capability to view websites, buy merchandise, and respond to advertisements or even questionnaires.

The multimedia files assigned to the zones can be assigned through action labels, which are specifically designed to provide the window browser 200 with interactive labels that can be used to access secondary multimedia files, such as Internet links, images, text and other media types. These secondary multimedia files are typically accessible at any time during the playback and as such do not necessary appear at any particular point or time during such playback. These secondary multimedia files are still encoded with the final encoded audio bit stream are different from the synchronized primary multimedia files in that the synchronized multimedia files are only viewable during a specific time and in most cases for a specific amount of time. The assign action labels tab 150a allows the user to assign and organize multimedia files to an action label.

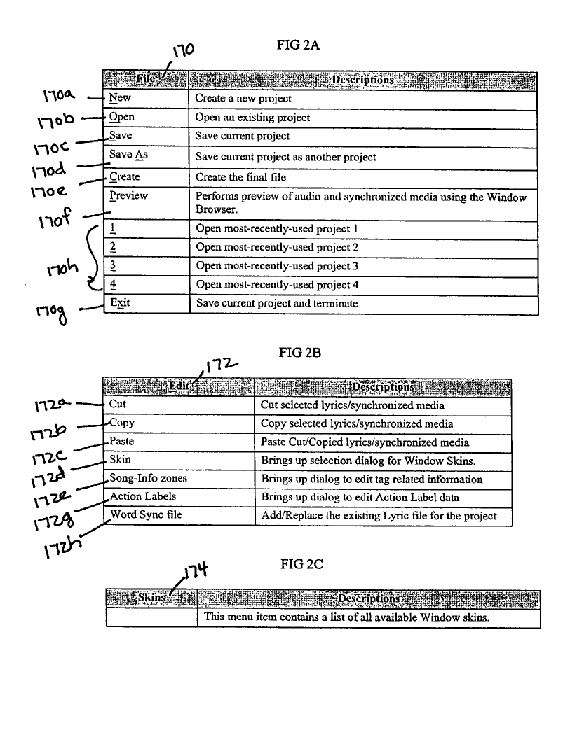

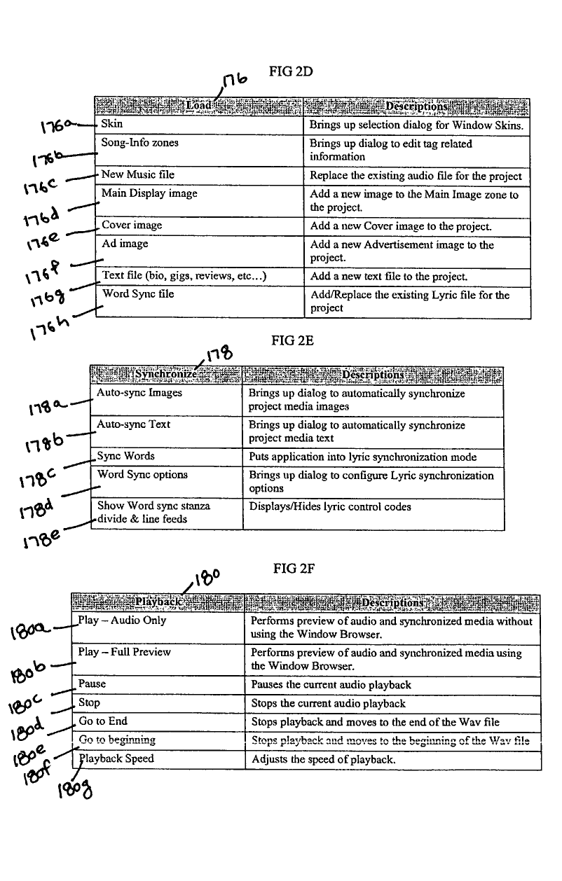

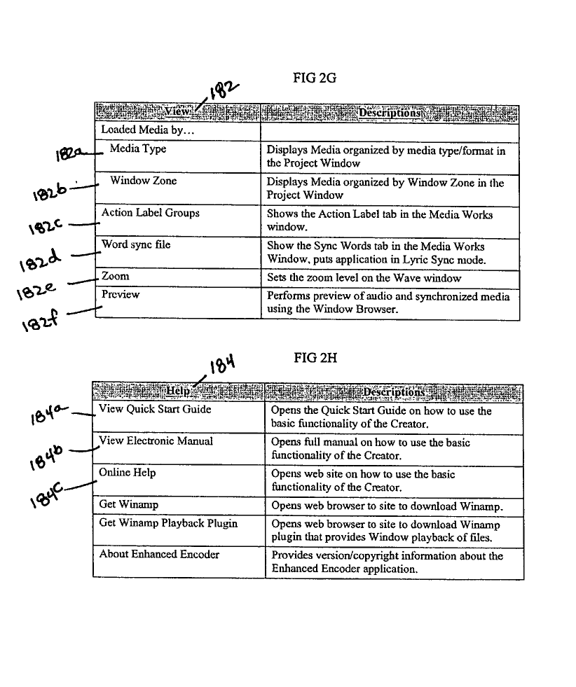

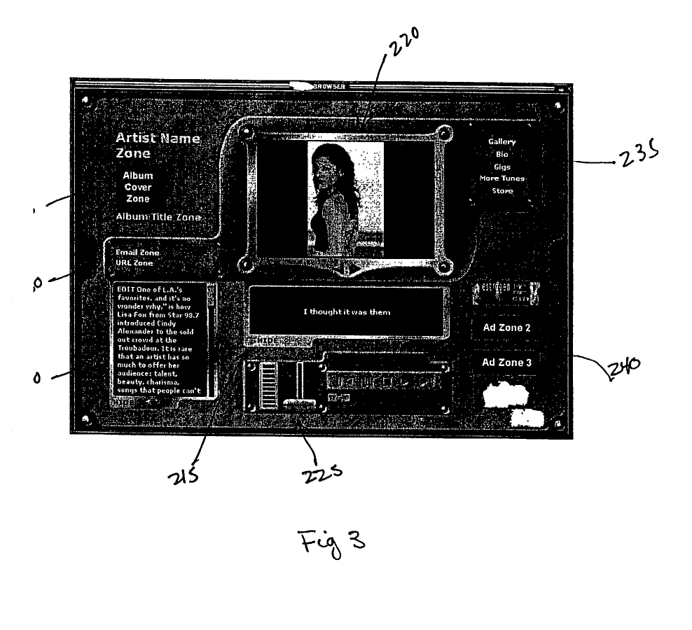

From the menu bar 90 various functions may be preformed to help create the synchronized multimedia bit stream. These functions are further listed or broken into function types that are accessed through drop-down menus. These menus and the functions listed thereunder are further defined and listed in FIGS. 2A-2H. FIG. 2A lists the functions that are accessed under the file menu 170, which include new 170a, open 170b, save 170c, save as 170d, create 170e, preview 170f, exit 170g as well as the ability to easily access the most recently used projects 170h. Under the new function 170a, the user has the ability to create a new project from scratch or from the beginning. The open function 170b allows the user to open an existing project, a project that has been previously saved. The save function 170c and save as function 170d permits the user to save the project under its current name or under a new name, respectively. The create function 170e, when selected, creates the final file that may be transferred or used on an audio player. The preview function 170f permits the user to preview the audio and synchronized media using the browser window 200. Lastly, the exit function 170g will save the currently project and terminate the program.

The following menu is the edit menu 172, which is illustrated in FIG. 2B. The edit menu 172 permits the user to access functions that allows the user to remove, change, or move media files as well as edit skins, zones, and file labels. The edit functions include cut 172a, permits the user to remove a selected lyric or synchronized media; copy 172b, permits a user to copy selected lyrics or synchronized media; paste 172c, permits a user to place cut or copies lyrics or synchronized media at a pre-selected position; skin 172d, permits a user to edit the information or characteristics regarding the current skin, referred to again in greater detail below; song-info zone 172e, permits a user to edit information stored in the song-info zones, discussed in greater detail below; action Labels 172f, permits a user to edit action label data, discussed in greater detail below; and word sync file 172g, permits a user to edit the existing lyric file in the project.

The skins menu 174, illustrated in FIG. 2C, permits the user to change the skin with previously loaded skins. A skin is typically used to refer to the overall appearance of a window. The overall appearance may include the color scheme as well as various nuances that customize the appearance to a particular user. As such each project may have a different skin, such that when a viewer is playing the finished project on another player, the viewer's player may automatically change skins to another skin that was originally designated for the particular song.

The load menu 176, illustrated in FIG. 2D, controls the ability to add various media files to the current project. The term “project” is used throughout to denote a user working on synchronizing data with the WAV file. The load menu 176 includes the following functions, skin 176a, song-info 176b, new music file 176c, main display image 176d, CD cover image 176e, AD image 176f, text file 176g, and word sync file 176h. In further detail, the load skin function 176a brings up a separate dialog window that permits the user to load a previously saved skin file to be used in a browser window when the song is played back. The skin file may be saved previously on the computer system being used to implement the enhance encoder functions or retrieved from the Internet. The load song-info function 176b brings up a dialog box to allow the user to edit information regarding the song, such as but not limited to record and artist information. The load new music file function 176c replaces or loads an existing audio file into the current project. The load main display image function 176d adds a new image to the main image zone. The load cover image function 176e adds a new cover image to the project, such as a CD cover. The load AD image function 176f adds a new advertisement image to the project. The load text file function 176g permits a user to add a new text file to the project. Lastly, the load word sync file 176h permits a user to add a lyric file to the project or replace the existing lyric file with a new lyric file.

The next menu is the synchronize menu 178, FIG. 2E, which include various functions that assist the user the synchronizing the multimedia files with the WAV file. These functions include auto-sync images 178a, which brings up a dialog box to automatically synchronize the project media images. When the auto-sync images 178a function is used, the images stored for the current project become listed in the media sync bar 120, this then permits the user to drag the images across the media sync bar 120 to a final position, which when finally placed will be synchronized at the position with the WAV file. An auto-sync text function 178b is also accessed through the synchronize menu 178. The auto-sync text 178b brings up a dialog box to automatically synchronize project media text. As mentioned with the auto-sync images function 178a, the auto-sync text 178b only lists the project media texts in the media sync bar 120. These are basically functions that assist the user in synchronizing the multimedia files. The next functions, sync words 178c and sync word options 178d, puts the enhanced encoder into a lyric synchronization mode and allows the user to configure various options, discussed in greater detail below. In addition a show word sync stanza function 178e displays or hides lyric control codes such as but not limited to verse dividers and line feeds, also discussed below.

The next menu is the playback menu 180, which is illustrated in FIG. 2f and includes the following functions, play audio only 180a, play-full preview 180b, pause 180c, stop 180d, go to end 180e, go to beginning 180f, and playback speed 180g. While most of these are self-explanatory, the play audio only function 180a, allows the user to only hear the WAV file, without playing back any synchronization multimedia files. The play-full preview function 180b permits the user to preview the project in its current state without having to send the project to an encoder. This lets the user determine if a portion of the synchronization is wrong or needs to be adjusted prior to encoding the synchronized multimedia bit stream.

The view menu 182 includes various functions that assists the user is displaying various characteristics of the enhanced encoder. For example, the view media by type 182a function permits the user to display the media in the project window 50 by the type or format of the multimedia files. The view media by window zone 182b function allows the user to display the multimedia files organized by the window zone in the project window 50. The view action label groups 182c function shows the action label tab 150a in the media works window 60. The view word sync file 182d functions shown the sync word tab 150b in the media works window 60. The zoom functions 182e set the zoom level on the wave window 20. The zoom level controls the amount of the WAV file that will be viewed on the screen at a single time. The amount is further shown by time in the time window 40. The view preview function 182f performs a preview of the WAV and synchronized multimedia files by opening the browser window 200 and playing back the files.

The main window 10 also includes a help menu 184 which allows the user to access a quick user guide 184a, a full user guide 184b, an online help guide 184c, and various other help functions. This may also include the ability to download new upgrades of the enhanced encoder software, pluggins, or software patches.

Some of the more commonly used functions may have shortcut icons on the tool bar 100. FIG. 5 tabulates some of the more commonly used functions. These include a new project icon 190a, an open project icon 190b, a save project icon 190c, a load media file icon 190d, an auto sync icon 190e, an action label icon 190f, a sync word icon 190g, an encode icon 190h, zoom in/out icons 190j and WAV file display box 190k and a preview icon 190m.

While most of these have already been discussed herein above, the encode icon 190g would be pressed when the project was finished. This would encode the WAV file (or the original audio file, from which the WAV was generated) and synchronized multimedia files into a single encoded audio bit stream. Various embodiments may encode the files into different formats or in different ways. For example, if the final project is to be encoded into a frame based audio bit stream, such as an MP3 format, the synchronized multimedia files may be encoded into an ID3 tag or more specifically in accordance with co-owned U.S. application Ser. No. 09/798,794. However, the synchronized multimedia files may also be embedded into the audio frames themselves or more specifically in accordance with co-owned U.S. application Ser. No. 09/507,084.

The functions in the present invention may also be classified into different categories, such as project functions, synchronization functions, utility functions, preview functions, encoding functions and playback functions. While the functions are listed in FIGS. 6a-6e, the functions may be found in the previously listed menus or invoked upon activating one or more of the functions in the previous menus, as such the functions are not necessary invoked through a separate menu.

The project functions 300, FIG. 6A, include open project, new project, project properties and save project. Project functions are used for recording and managing project information, which includes files and properties. A project when created includes three files; they are the input audio file, secondary or intermediate file and an out file. The audio file could be, as mentioned above, in any form but is converted to a WAV file format for easy use and manipulation. However, it should be known that the audio file format used might be changed without changing the scope of the invention. The secondary file is used for storing lyric and media synchronization information and the out file is a time stamp file for all the synched information. The out file is not required while opening a new project. It is generated during the synchronization process and only used to dynamically show users time stamps of synchronized media data.

The open project function 170b, when selected from the file menu 170, opens a dialog box that lists files on the system that may be opened. Users can chose a desired project file by navigating different folders. All the source files associated with the project will also be opened and loaded to the project workspace or windows. If one of those files (a music file or secondary file) is missing, a message box 330 will be displayed, FIG. 7. The new project function 170a, when selected from the file menu 170, opens a project property window 310, FIG. 8a, that permits the user to open and associate a music file, lyric or text files and image or other multimedia files to the new project. It is important to note that more then one text or multimedia file may be selected at a time, upon which a separate list will be displayed indicating all of the files selected. If the lyric file does not previously exist, the user may create the lyric file or any other text files using a text editor attached to the enhanced encoder. The selected files can also be reordered, deleted, replaced or new ones added on at any time during editing the project.

Project properties can also be changed and set by using the properties function 302. Properties in each project may include various mandatory, optional and automatic fields. These fields are listed in FIG. 8b and includes for example, setting the language, group number, title or song, album title, artist name, etc. When invoked, a project property window box 340, FIG. 9, will open to provide an easy way to enter or modify project properties. As stated above, information will be entered into a box displayed in the project property window box 340. Information such as title of the song 340a, year song was released 340b, album title 340c, artist's name 340d and track number from the album 340e are but only a few of the fields which may be present.

The synchronization functions 320, FIG. 6B, provides for the synchronization of the multimedia data. Synchronization may be done manually or automatically and as mentioned in greater detail below, as the project is being created an LRC file is generated as the previously named intermediate file to record all the information regarding the synchronization process.

Utility functions 322, FIG. 6C, would include editing of the text files, converting the audio files into working project files, the ability to preview and play the projects both unfinished and finished, as well as editors for the labels, information tags, discussed in greater detail below, and various graphic user interface windows. The encoding functions 324, FIG. 6D, and the player functions 326, FIG. 6E, provide the user with the ability to encode the final finished project and play the files, respectively.

The present invention as mentioned above allows for both lyric synchronization and other multimedia synchronization. Lyric synchronization is mainly used for karaoke display and highlight. In a karaoke display, the user listens to the music of a song without the original artists voice. The user then reads lyrics off of a display and sings along with the music. The lyrics and in some instances the syllables are further highlighted to indicate to the user when a particular lyric is to be song. While creating a project the user typically synchronizes the lyrics with the original song, such that the user knows when and where a particular lyric or phrase starts and ends by listening to the original artist's voice. However, when encoding the finished project the audio file encoded may include the music file that does not have the artist's voice, such that during play back the viewer, or person playing, only hears the music and can read and sing the displayed synchronized lyrics. In other playback modes, the viewer would have full capabilities to view all synchronized multimedia data, which as mentioned above includes pictures, video, text, hyperlinks, etc. Nevertheless, the present invention provides full support for the user to synchronize lyrics for both karaoke display or for normal display.

When synchronizing lyrics, tags are used to assist the players in displaying the lyrics from the finished project. An <SD> tag is used to denote the end of a verse, while an <LF> tag is used to denote the end of a line. A typical display window on a player allows for a couple of lines of text to be displayed at one time. Moreover, when listing lyrics, it is typically proper to list a couple of lines or an entire verse so the viewer has the opportunity to see more then one word at a time. As such, when decoding or playing back the project, the player will be able to display an entire verse on the screen at a time by reading the lyrics in between <SD> tags. In addition, the player will be able to distinguish how many words should be displayed on a line by displaying lyrics in between <LF> tags.

Referring now to FIG. 10, a distinguishable lyric unit is defined between two adjacent “space” characters, or two “@”s, or a space and a “@”. As shown in the media works window 60, lyrics are displayed and are currently in the process of being synced with the WAV or audio file. An “@” is also used to denote a syllable divider, which will not be displayed in the playback. Other characters may be used without diverging from the scope of the invention. A sync word 350 is used to sync lyrics, which may also be activated by the sync word icon 190g on the tool bar 100. When pushed, the media works window will switch to synch word mode, the lyrics that are stored in a text file will be displayed sequentially in the media works window. BY pushing sync word button 390, the lyrics will be displayed in the word sync bar 110. The next lyric unit and the current sentence will be sequentially displayed under the synchronization window. They can be jumped manually by positioning the cursor in a different location of the text file in the media works window. Lyric and tags, such as <SD> and <LF> positions can be adjusted in the synchronization window 30. Various ways can be used to move and adjust the lyrics, such as drag and drop, copy/paste, and manually adjusting the time stamp. When the lyrics are synchronized or placed on the word sync bar 110, the lyrics become time stamped. The actually time stamped can be viewed in the sync times window 80. By highlighting and clicking an element in the sync times window 80, whether it is the lyric or other multimedia file, a dialog box 350, FIG. 11, will appear allowing the user to view the current or old time stamp 350a and permit the user to adjust the time by inserting a new time stamp 350b.

In addition and as shown in FIG. 10, lyrics may also be synced by line. In the media works window 60, there is provided a word sync 351a or line sync 351b toggle. The line sync would operate under the same conditions and the word synchronization discussed throughout.

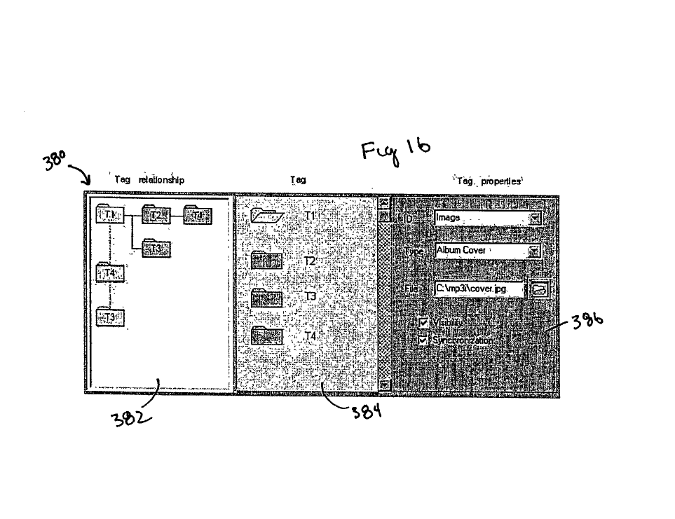

When auto synchronizing the lyrics or other multimedia data, a settings dialog box 360, FIG. 12, will be accessed such that various options may be changed. Options such as pre-display time 360a and gap insufficient pre-display 360b are two such variables that may be changed. The pre-display time 360a for an <SD> tag indicates the time difference between displaying the following text and starting to operate highlighting. This permits the user to display the text prior to highlighting in order to give the viewer the opportunity to review the displayed lyrics. In addition the pre-display time 360a for an <LF> tag indicates the time difference between displaying the first text unit on the next line following the <LF> tag. Again, in order to give the viewer the opportunity to review the following line of lyrics the pre-display time 360a is a lag between displaying the next lyrics. Because the operation order for lyric display and highlighting is “display a verse→highlight characters in the verse→display the next verse→highlight characters in the next verse . . . ”, when the above pre-display time setting value is too big, and the actual time difference between highlighting the last character in a previous verse and highlighting the first character in the next verse is too small, the gap insufficient pre-display 360b sets a percentage of the time gap to be taken as the value for positioning the tags. As such for a <SD> tag it is the time difference between highlighting the last character in a previous verse and highlighting the first character in the next verse and for an <LF> tag is it the time difference between the last lyric on a previous line and the first lyric on the current line. Other options are also available such as but not limited to the display of the “@” and tags in the synchronizations window 30.

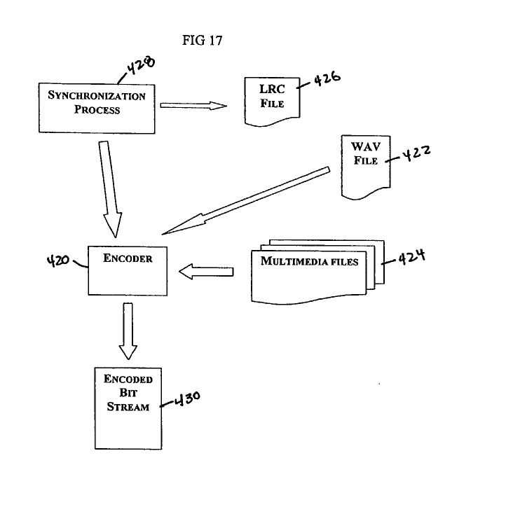

The settings dialog box 360 may also be used to copy and paste groups of lyrics. When lyrics have the same number of words/syllable symbols and relative sync time, the time stamps can be duplicated by using the time stamp copy function in the lyrics source file tag 362, FIG. 13. For example, to duplicate the time stamp in sentence 1 to sentence 2, one would highlight sentence 2 and copy them to the lyrics clip board 364, FIG. 14a. Then select the sentence 1, which have been already synchronized, from the synchronization window 30, FIG. 14b and copy them by using a popup menu 370. Next, move to a position to insert the lyrics from sentence 2 and paste sentence 2 from the lyrics clip board 364 to the current position. Select the first word of the now pasted lyrics, and chose “fill in time stamps” 366. The lyrics on the lyrics clip board will take place of the lyrics at the insert position and will have the time stamps outlined from sentence 1. In addition and as mentioned above, the lyrics or other text files may be edited in this lyric source file, initiated by the lyric source file tab 362, FIG. 13. This would also be the point where additional “@” syllable separator would be added or changed. In addition other quick editing may be performed, for example a “@” syllable separator may be placed throughout the text file in the same position for the same words. As such, if a word such as “dashing” appeared several times in the lyrics, the “@” syllable separator would only have to be placed in one of the appearances of the word, and the rest would be automatically changed.

Also shown in the settings dialog box 360, FIG. 13, is the LRC file tab 368. The LRC file is an intermediate file that is created when the current project is saved prior to encoding a finished project. It is the output file of the sync function and the input file for the encoding function.

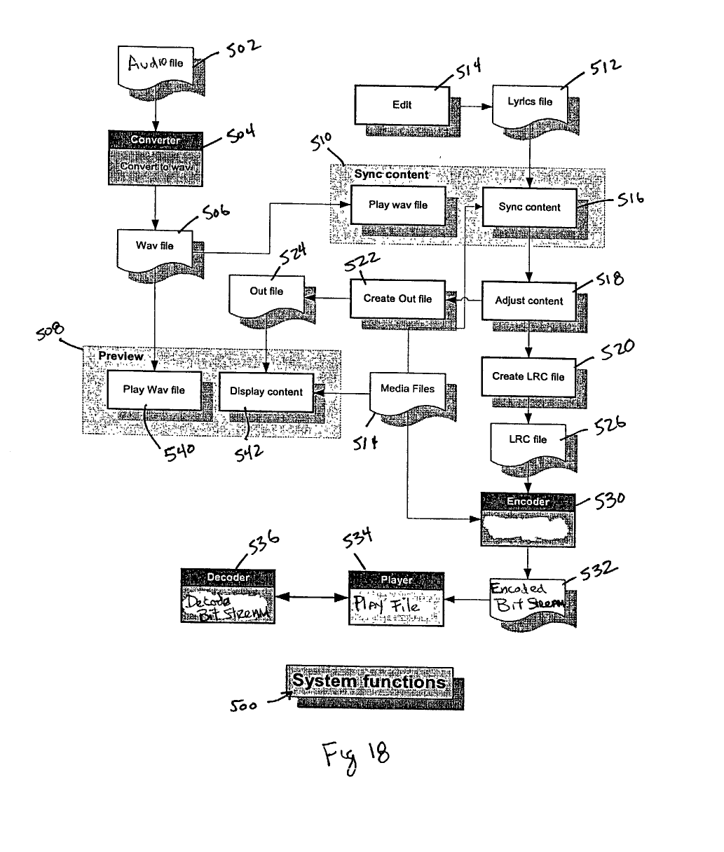

Another aspect of the present invention may include the synchronization of “info tags.” Info tags are multimedia file containers that can include multiple and different multimedia files linked to each other. Referring now to FIGS. 15 and 16, any info tag can have unlimited child tags that are used to store associated information. For example, FIG. 15 shows a tag hierarchy 400. The first or parent tag 402 is an album cover tag, which includes an image info tag 404. The image info tag 404 may further include two child tags 406 and 408. The first child tag 406 may be a text info tag for the artist's biography information and a second child tag 408 may also be a text info tag for liner notes. The artist's biography info tag 406 may also have a child tag 410 that is an audio info tag for storing an audio clip such as a greeting from the artist. Moreover, addition tags 412 may be associated with the album cover tag 402 without having further association with the other child tags.

The tags can be delivered along the encoded audio bit stream in either primary or secondary form, as previously distinguished. When they are secondary, they can be accessed at any time during the audio playback. When they are primary, it can only be obtained at certain time spots with or without duration restrictions. The info tags may be inserted to the media works window 60 by using “drag and drop” functions. They can be synced automatically or manually and can be adjusted similarly as with the other multimedia files. To create the various relationships and properties of the info tags, an info tag editor 380, FIG. 16, may be used. The info tag editor is separated into three windows, a tag relationship window 382, a tag window 384 and a tag properties window 386. The tag relationship window 382 shows current relationship status between the info tags by tree structures. Dotted lines indicate independent tags while solid lines denote dependency. As shown in the tag relationship window 382, info tags may be used more than once, such as Info Tag 4 as illustrated is a child tag of tag 2 and as an independent tag. In such circumstances, the re-used tag would not necessarily be copied twice but a dynamic relationship may be created that would point to the tag each time it is used. Tag window 384 lists the tag currently opened and lists all the dependent tags underneath. The tag properties window 386 identifies the tag properties associated with the opened tag. At which point the user can edit the properties.

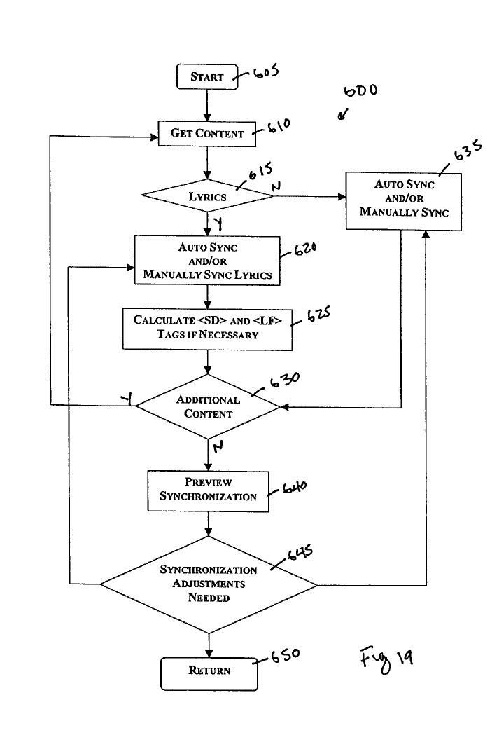

Referring now to FIG. 17, after synchronization of the project is completed the user may encode the final project into an encoded bit stream. When the user invokes the encoder function, the built-in encoder 420 of the present invention receives all of the various files, such as the WAV file 422, multimedia data files 424 and the LRC file 426 created by the synchronization process 428 to create a single encoded bit stream 430. The encoder may encode the bit streams in accordance with various methods disclosed in co-owed applications, such as Co-Owned application Ser. No. 09/507,084; Co-Owned application Ser. No. 09/798,794; and Co-Owned application Ser. No. 09/967,839; for which permit the encoding of synchronized multimedia files within the audio frames or attached to the audio bit stream with proper pointers or links. However, the encoder may further encode the bit streams in accordance with various bit stream or frame based formats known in the prior art. The enhancement to the encoder being the ability to encode the synchronized multimedia files along with the audio file such that during playback the files provide an interactivity that does not exist in the prior art.

Referring now to FIG. 18, the present invention's system functions 500 are outlined in a block diagram. In accordance therewith, an audio file 502 is received by the converter 504 and converted to a WAV file 506. The WAV file 506 may be used throughout the various system functions, such as but not limited to a preview function 508 and a synchronization function 510. A lyric file 512 is also provided to the system 500 for which an editor 514 may be used to create or modify the lyric file 512. The lyric file 512 is also provided to the synchronization function 510 in order to be synchronized with the WAV file 506. Multimedia files 514 are further provided to the system 500, which are used by the preview function 508 and the synchronization function 510. The lyric file 512 and multimedia files 514 are provided to a synchronization content function 516 that the user uses to adjust the content 518 such that the files 512 and 514 are synchronized either primarily or secondarily. Upon adjusting the content, the system 500 creates 522 an out file 524 that is used by the preview function to determine if synchronization was accurate. Moreover during the preview function 508, the function plays 540 the WAV file and displays 542 the out file 524 and the multimedia files 514 such that the user can determine if further adjustments are needed.

The adjusting content function 518 further creates 520 an LRC file 526 to temporarily store synchronization information. The LRC file 526 is used by the encoder 530 when the project is finished or when the user decides to encode the audio file and multimedia data 514. The encoder creates an encoded bit stream 532 that contains the synchronized multimedia files. The encoded bit stream 532 can then be played back on a player 534, which would send the encoded bit stream to a decoder 536 that decodes the audio file and synchronized multimedia files for simultaneous synchronized playback.

Referring now to FIG. 19, there is shown a synchronization function 600. The synchronization begins 605 by retrieving various content files 610. The content files are various multimedia files discussed hereinabove. If one of the content files is a lyric file 615 the user will use various functions to auto sync or manually sync the lyrics 620. This may be done by inserting and placing various <SD> and <LF> tags 625. If there is an additional content file 630, the function will return to retrieve additional content files 610. Additionally, if the file is not lyrics 615, the user will have the ability to auto sync or manually sync the other multimedia files 635, which once completed the user will again determine if additional content needs to be retrieved 630.

If there is no additional content the user can preview the synchronization 640, by utilizing the preview features previously discussed. After previewing the synchronization, the user has the option of whether or not the synchronization needs adjustments 645. If so, the user can return to auto sync or manually sync the multimedia files and/or lyrics 635 or 620. If the synchronization does not need adjustment the user is done 650 and may encode the files.

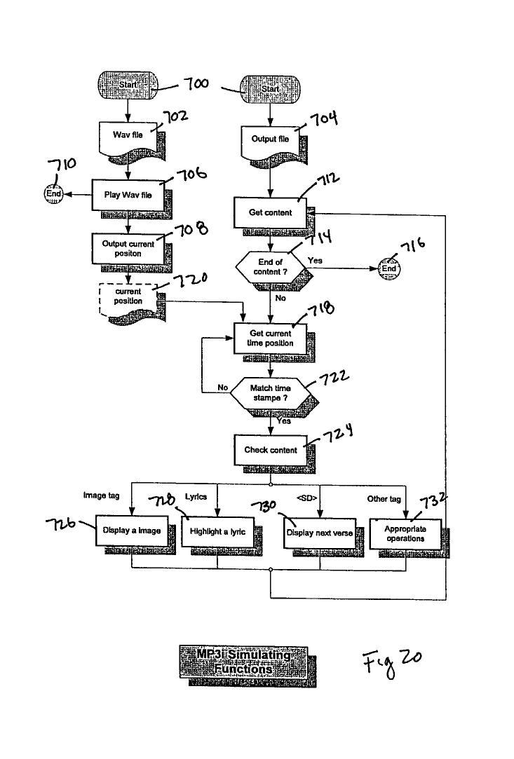

Referring now to FIG. 20, a preview function is described in better detail and in accordance with one embodiment of the present invention. When initiated 700, the preview function retrieves the WAV file 702 and the out file 704, previously discussed. The WAV file is played 706 and provides an output of the current position 708, that changes throughout the playing. Once the WAV file has played throughout, the file is done 710. While the WAV file is playing, the out file 704 is played as well in which content that is primarily or secondarily synchronized is invoked and/or played. When the function, comes across a multimedia file 712, the function may determine if it is the end 714 of the out file 704. If it is the end of the out file then the preview function for the out file will end 716, allowing obviously the WAV file to finished if there is any portion remaining. However, if it is not, then the preview function will retrieve the current position 718. The current position 720 is determined from the WAV file player 706. The time stamp associated with the content and the current position time are checked against each other 722. If the times match then the preview check the multimedia content 724 to determine how to proceed with the specific type of multimedia file. If the content is an image tag the player is display the image 726; if the content is a lyric the play may highlight the lyric 728; if the content is a <SD> tag then the player will retrieve and display the next verse 730; and if the content is another type of tag appropriate operations associated therewith will be preformed 732. The preview will then continue to process the next content. If however, the time stamps do not match 722, the preview will continue to play the WAV file and retrieve the updated current position until a match is made.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A computer readable medium for synchronizing multimedia files into an audio bit stream, having computer-executable instructions that cause the computer to perform a method comprising:
receiving an audio file;
receiving at least one multimedia file;
synchronizing the at least one multimedia file with said audio file, wherein the step of synchronizing includes the step of generating an intermediate file that includes for each multimedia file a corresponding time stamp to indicate the position and time for where said multimedia file is to be synchronized within said audio file; and
encoding the audio file with the at least one multimedia file to generate a single audio bit stream, wherein during the step of encoding the intermediate file is used to synchronize the at least one multimedia file with said audio file to generate a single audio bit stream that includes embedded synchronized multimedia files.

2. The method of claim 1, wherein when the multimedia file includes lyrical data that corresponds to an original voice recording that is heard during the playback of the audio file, the synchronizing step further includes:
defining syllables, verses and end line tags within the lyrical data; and
synchronizing the lyrical data in accordance with the syllables, verses and line tags such that during playback the lyrical data is synchronized with the audio data such that the lyrical data matches the original voice recording.

3. The method of claim 2 further comprising previewing the step synchronizing the at least one multimedia file with the audio file prior to the step of encoding.

4. The method of claim 3 further comprising re-synchronization the at least one multimedia file with the audio file prior to the step of encoding and after previewing when the synchronizing of the at least one multimedia file with the audio file needs modification.

5. The method of claim 4 further comprising the step of encoding additional multimedia data within the single audio bit stream, wherein said additional multimedia data is invoked during the playback of said single audio bit stream but is not synchronized to a particular position within the single audio bit stream.

6. The method of claim 5, wherein during the encoding step the at least one multimedia file is synchronized with a second audio file that does not include original voice recording.

7. The method of claim 1, wherein the multimedia file is selected from at least one of the following types of multimedia files: text files, lyrical files, audio files, video files, information tags, advertisement files, hyperlink files, hypertext files, dynamic multimedia files, or static multimedia files.

8. In a graphical user interface method for a program readable machine embodying a program of instructions executable to permit the synchronization of multimedia files with an audio file to create a single encoded audio bit stream with synchronized multimedia files, the method comprising:
having a means for selecting and loading multimedia files which may include: an audio file with a voice recording, a lyrical file containing lyrical data corresponding to the voice recording on said audio file, and additional multimedia files;
having a means for modifying or creating the lyrical file including the ability to separate the lyrical data by syllables, verses and lines;
having a means for automatically or manually synchronizing the lyrical file with the audio file such that the lyrical data matches the voice recording on said audio file to create a synchronized lyrical file;
having a means for automatically or manually synchronizing the additional multimedia files with the audio file to a desired position in the audio file to create synchronized multimedia files; and
having a means for encoding the synchronized lyrical file and additional multimedia files with the audio file to create a single encoded bit stream with synchronized data.

9. The method of claim 8 further comprising having a means for previewing the synchronized lyrical file and additional multimedia files with the audio file, prior to encoding.

10. The method of claim 9 wherein the means for previewing includes opening a new browser window, wherein multimedia files and lyrical data are displayed in sub-windows.

11. The method of claim 10 wherein the multimedia files displayed in said sub-windows includes one or more of the following static or dynamic multimedia files: pictures, video, additional audio files, advertisements, biographic information, lyrics, hyperlinks,

12. The method of claim 8 further includes placing loaded multimedia files in a first window.

13. The method of claim 11 further includes placing synchronized multimedia files in a second window.

14. The method of claim 12 further includes placing a time stamp corresponding to the synchronized multimedia file in a third window.

15. The method of claim 8 further includes creating a single channel waveform from the audio file and displaying said single channel waveform in an audio window.

16. The method of claim 9 further includes creating synchronization bars to graphically display the position of synchronized multimedia files along the single channel waveform.

17. A user interface for synchronizing multimedia files into an audio bit stream comprising:
a means for retrieving an audio file having at least a voice recording;
a means for retrieving at least one multimedia file, and when the multimedia file includes lyrical data that corresponds to the voice recording on the audio file, a means for defining syllables tags within the lyrical data;
a means for synchronizing the at least one multimedia file with said audio file, and when said multimedia file includes lyrical data a means for synchronizing the lyrical data with the voice recording in accordance with the syllables tags, wherein said synchronizing means generates an intermediate file that includes for each multimedia file at least one corresponding time stamp to indicate the position and time for where said multimedia file is to be synchronized within said audio file; and
a means for encoding the audio file with the at least one multimedia file to generate a single audio bit stream, wherein the means for encoding uses the intermediate file to position and encode the at least one multimedia file with said audio file such that a single audio bit stream is generated that includes embedded synchronized multimedia files.

18. The interface of claim 17 further comprising:
a means for defining verse and line tags when the multimedia file includes lyrical data, wherein said verse and line tags are used to defining the display of said lyrical data during a playback of the single audio bit stream with synchronized multimedia files.

19. The interface of claim 17 further comprising a means for automatically synchronizing multimedia files.

20. The interface of claim 17 further comprising a means for generating and displaying a single channel waveform from the audio file in order to visually assist the synchronization of multimedia files with the audio file.

21. The interface of claim 17 further including a means for creating a time stamp corresponding to the multimedia file or each syllable in lyrical data and a means for manually altering said time stamp.

23. The interface of claim 18 further including a separate browser window for previewing the synchronized multimedia files with audio file.

24. The interface of claim 23, wherein the separate browser window includes a display window for displaying lyrical data and the lyrical data is highlighted and/or displayed in accordance with the syllable tags and/or the verse and line tags.

25. The interface of claim 18, wherein the multimedia file may include one or more of the following data types: audio, picture, video, text, lyrical, hypertext, hyperlink, advertisement, or information tags.

26. The interface of claim 25, wherein when a multimedia file is retrieved, the multimedia file is displayed in a first window.

27. The interface of claim 26, wherein when the multimedia file is synchronized with the audio file, the multimedia file is displayed in a second window and a time stamp is created.

28. The interface of claim 27, wherein the time stamp for the synchronized multimedia files may be viewed and modified in a third window.

29. The interface of claim 17, wherein the multimedia file may be encoded with a second audio file that does not include the voice recording.

30. The method of claim 1, wherein during the encoding, the audio file is converted into a plurality of audio frames and the at least one multimedia file is embedded within the audio frames in accordance with the time stamps.

31. The method of claim 1, wherein during the encoding, the audio file is converted into a plurality of audio frames and the time stamps and a pointer corresponding to the multimedia files are embedded within the audio frames and the multimedia files are attached to the audio frames to form a single encoded audio bit stream.

32. The method of claim 1, wherein during the encoding, the multimedia files along with a corresponding time stamp are attached to the audio file such that the encoding step encodes a single encoded audio bit stream with synchronized multimedia files.
